(19) United States
(12) Patent Application Publication
(10) Pub. No.: US 2007/0234613 A1
(43) Pub. Date: Oct. 11, 2007

(54) Circumstances communication devices and method

(76) Inventor: Jodi Aiken, Kennedy, NY (US)

Correspondence Address: Christopher J. Whewell;Western Patent Group, 6020 Tonkowa Trail, Georgetown, TX, 78628, US

(21) Appl. No.: 11/725,786

(22) Filed: Mar. 20, 2007

Related U.S. Application Data
(60) Provisional application No. 60/787,650, filed on Mar. 31, 2006.

(51) Int. Cl. G09F 7/12

(52) U.S. Cl. 40/594

(57) ABSTRACT

Provided are signs comprised of flexible polymeric materials, which may be adhered to substantially flat surfaces by electrostatic attraction. The signs of the invention provide personal medical information concerning an individual who is normally situated in an area in the general whereabouts of the sign, so that other persons visiting the area can be readily informed of personal and/or medical information concerning the individual. The information displayed may relate to such topics as a do-not-resuscitate order, organ donor provisions; the use of oxygen; the existence of a living will; and the existence of a health care proxy, among other things.

### CROSS-REFERENCES TO RELATED APPLICATIONS

This application claims the benefit of U.S. Provisional Application No. 60/787,650 filed Mar. 31, 2006, the entire contents of each of which are herein incorporated by reference.

### TECHNICAL FIELD

This invention relates generally to the field of information communication. More particularly, it relates to devices and methods useful in the communication of medical, legal, and other information to professional caregivers and others during a critical encounter with a patient, such as when a patient is found to be unconscious.

### BACKGROUND

It is common for professional caregivers, such as emergency medical services providers, to cite but one example, to routinely be called to locations where a person is or has undergone a traumatic experience, such as a home or office setting. The traumatic experience may include any event or experience which necessitates the summoning of a professional health care-giver to the place at which the person experiencing the trauma is located, which may include without limitation a home, office, or public domain location. Often, such experiences can include strokes, heart attacks, loss of consciousness, hypoglycemia, and head and neck injuries. In such critical encounters between a care provider and a patient, it is not infrequent that the person undergoing the trauma has particular historical circumstances, facts, and/or other information which, if known to the caregiver, would result in an enhanced level of service, different diagnoses or judgments, or the avoidance of any of a number of potential detriments, versus the case where such circumstances, facts, and/or other information is unknown to the caregiver. For example, where a traumatized person has installed a “do not resuscitate” (“DNR”) order, it would be incorrect for care-giving personnel to resuscitate such a person, even though EMS personnel are, by default, charged with saving lives. By resuscitating a person having a DNR order, care providers can be actually doing a disservice to such patients. However, the question arises as to how a caregiver or would-be good Samaritan can know in advance of a DNR order, or other information pertinent to the traumatized person's disposition.

Another situation which could arise is where oxygen is in use in a home, and in such instances it would be beneficial for city services providers, i.e., firefighters, paramedics, EMS personnel, nurses and others to be aware of the presence of oxygen in the home. Having such information can alter people's decisions relative to actions they may subsequently implement absent the same information.

Unfortunately, even though society has evolved to have a relatively high capacity for communication, there remains a need in the care-giving industries for effecting rapid, clear, and concise communication of critical information that is necessary to render correct decisions. Durable Medical Equipment (“DME”) Companies, including those providing oxygen services, are slated to become accredited in the very near future by organizations which may include the Joint Commission of Accreditation of Healthcare Organizations (“JCAHO”). During an accreditation, an organization is assessed with particular attention being paid to the Care Environment section of the proposed standards, in which safety risks are identified and managed. Although seemingly simple on its face, one of the most difficult tasks for a DME company is to assure that each patient on the service rolls has a proper oxygen-in-use sign displayed in a conspicuous location. In many instances, for whatever reason, a sign once properly placed is no where to be found at a point in time in the future, and a missing sign results in an infraction if a clinician or service technician that accompanies a surveyor during an audit fails to notice an oxygen-in-use sign as being absent. Two infractions can result in a violation, and in such a case the DME company risks losing their accreditation.

Use of a sign according to the present invention can eliminate issues of durability associated with less durable paper products which may result in violations stemming from absent signs or placards.

### BRIEF DESCRIPTION OF THE DRAWINGS

In the annexed drawings:

FIG. 1 shows a front perspective view of a placard or sign according to one embodiment of the invention, useful in carrying out a process of communicating a message according to another aspect of the invention;

FIG. 2 shows a front perspective view of a placard or sign according to an alternate embodiment of the invention, useful in carrying out a process of communicating a message according to the invention;

FIG. 3 shows a front perspective view of a placard or sign according to an alternate embodiment of the invention, useful in carrying out a process of communicating a message according to the invention;

FIG. 4 shows a front perspective view of a placard or sign according to an alternate embodiment of the invention, useful in carrying out a process of communicating a message according to the invention;

FIG. 5 shows a front perspective view of a placard or sign according to an alternate embodiment of the invention, useful in carrying out a process of communicating a message according to the invention;

FIG. 6 shows a side perspective view of a placard or sign according to the invention, useful in carrying out a process of communicating a message according to the invention; and

FIG. 7 shows a perspective view of signs according to the invention disposed in various locations of their deployment.

### SUMMARY OF THE INVENTION

The present invention provides a sign that is capable of adhering to a flat or substantially flat surface, including without limitation porous and non-porous surfaces, which sign comprises a flexible sheet of a polymeric material, wherein the sign has a front face portion and a rear face portion, and further comprising a health-related message disposed on one or more of the front face portion and the rear face portion.

The invention also provides a combination comprising: a) a flat surface; and b) a sign as mentioned above, adhered to said surface by electrostatic forces, wherein the health related message contains subject matter selected from the group consisting of: a do-not-resuscitate order; an organ donor provision; the use of oxygen; the existence of a living will; and the existence of a health care proxy.

The invention also provides a process for informing a first person of medically-related information of a second person which comprises the steps of: a) providing a sign as mentioned above; b) providing a written message on at least one face of said sign that contains personal information; c) placing said sign on a flat surface, in the substantial absence of an adhesive substance, wherein the flat surface is in a conspicuous location relative to the general whereabouts of the person to whom the information pertains, so as to provide a display of such information, sufficient to alert persons visiting the conspicuous location as to the existence of said information pertinent to said second person.

### DETAILED DESCRIPTION

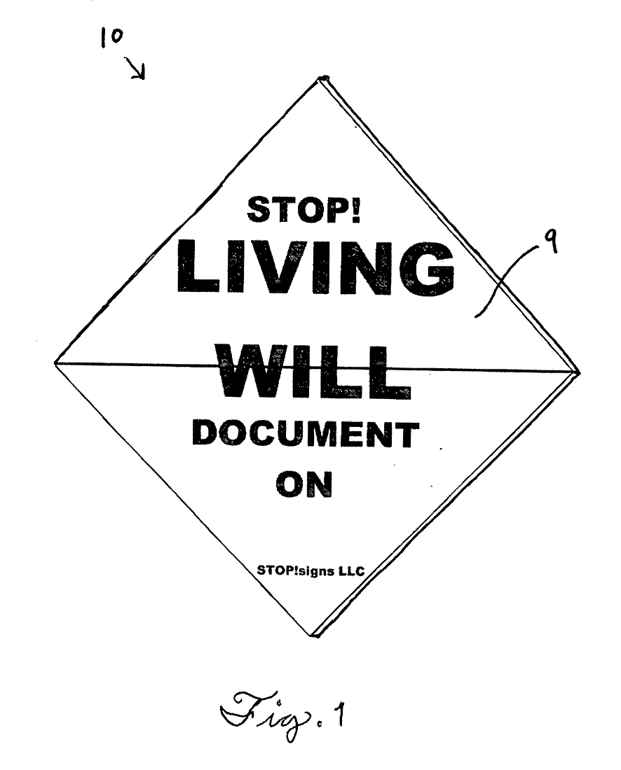

Referring to the drawings and initially to FIG. 1 there is shown a front perspective view of a sign 10 (or placard) according to the invention, useful for carrying out a process of communicating a message according to the invention. Such a sign 10 includes a front face portion 9, having a message displayed thereon, which message provides information that is useful by caregivers at the time of a critical event, for aiding them in making a decision, by enabling them to take into consideration particular information about the patient or surroundings which are displayed on the sign 10, which in this instance relates to the existence of a living will document.

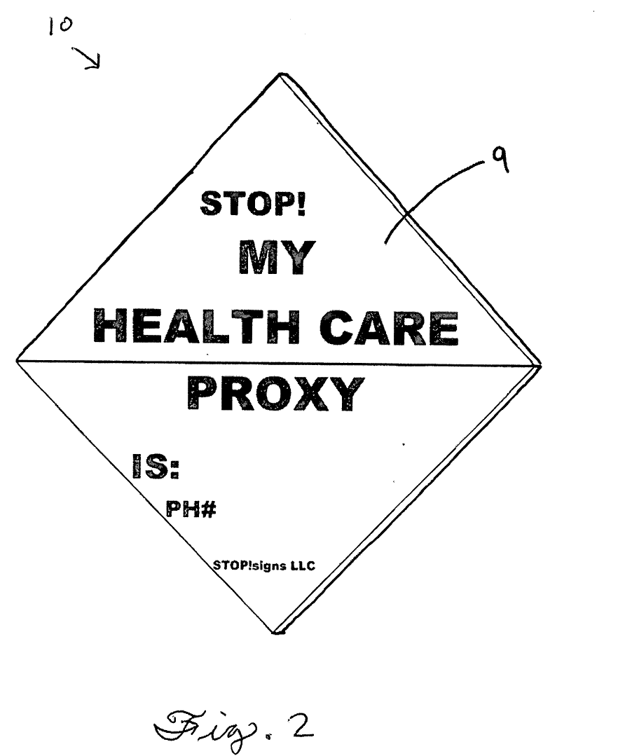

FIG. 2 shows a front perspective view of a sign 10 according to an alternate embodiment of the invention, useful in carrying out a process of communicating a message according to the invention. In this embodiment, the sign 10 comprises a front face portion 9, having a written message displayed thereon for similar purposes as that described for FIG. 1, except the message displayed relates to the existence of a health care proxy.

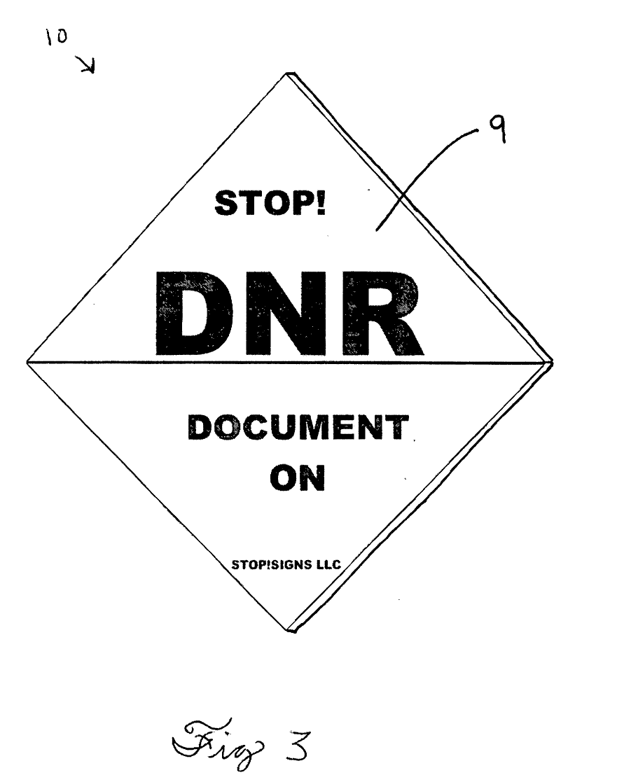

FIG. 3 shows a front perspective view of a sign 10 according to yet another alternate embodiment of the invention, useful in carrying out a process of communicating a message according to the invention. In this embodiment, the sign 10 comprises a front face portion 9, having a written message displayed thereon for similar purposes as that described for FIG. 1, except the message displayed relates to the existence of a “do not resuscitate” order.

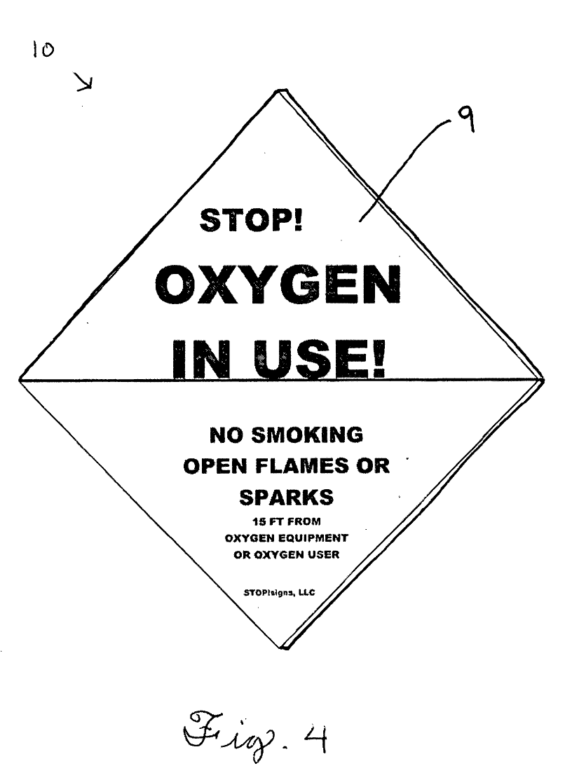

FIG. 4 shows a front perspective view of a sign 10 according to yet another alternate embodiment of the invention, useful in carrying out a process of communicating a message according to the invention. In this embodiment, the sign 10 comprises a front face portion 9, having a written message displayed thereon for similar purposes as that described for FIG. 1, except the message displayed relates to the existence of oxygen in use on the premises.

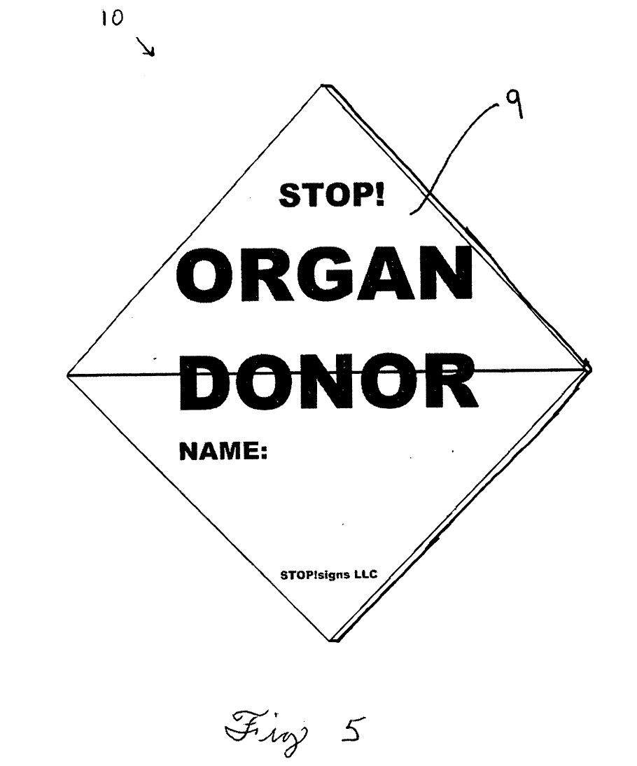

FIG. 5 shows a front perspective view of a sign 10 according to yet another alternate embodiment of the invention, useful in carrying out a process of communicating a message according to the invention. In this embodiment, the sign 10 comprises a front face portion 9, having a written message displayed thereon for similar purposes as that described for FIG. 1, except the message displayed relates to the person on the premises being an organ donor.

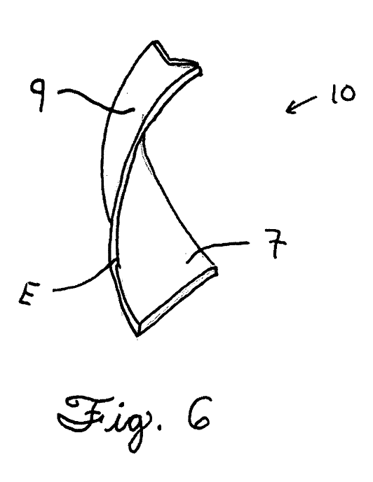

FIG. 6 shows a side perspective view of a sign 10 according to the invention, useful in carrying out a process of communicating a message according to the invention is In this FIG. 6 there is shown the front face portion 9, rear face portion 7, and edge portion E. A written message may be disposed either on the front face portion 9 or the rear face portion 7, or both.

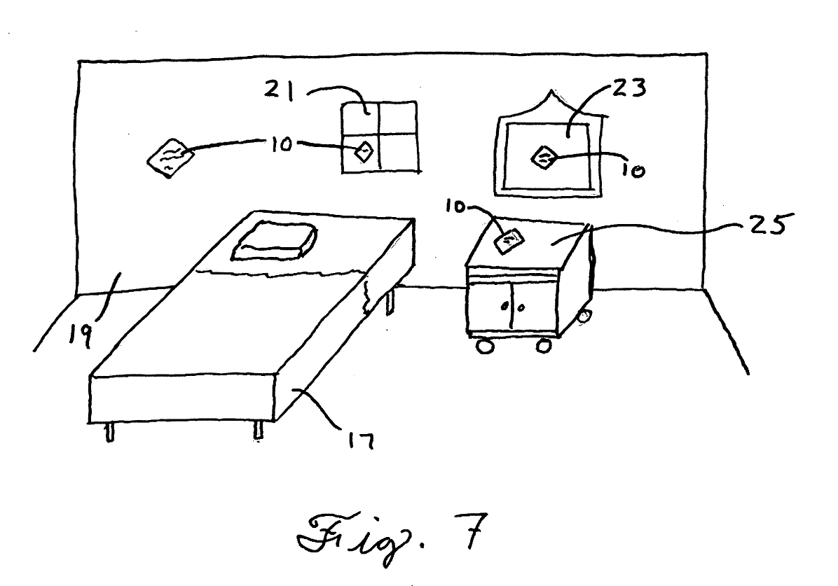

FIG. 7 shows a perspective view of signs according to the invention disposed in various locations of their deployment. In this FIG. 7 there is shown a bed 17, disposed adjacent to wall 19, which includes a window 21 and also has a mirror 23 hung thereon. There is further a table or nightstand 25, having a horizontal surface at its top portion. A sign 10 according to the invention is shown disposed at various locations on the wall 19, window 21, mirror 10, and the horizontal surface on the table or nightstand 25.

Thus, the present invention provides signage wherein the signs preferably comprise a sheet of a polymeric film having any thickness in the range of between about 10 microns to about 3000 microns, wherein said polymeric film comprises a front face portion 9 and a rear face portion 7, and wherein at least one of said face portions has a message printed thereon. This includes all possible ranges therebetween, including without limitation, the ranges: 15 microns to about 2500 microns; 20 microns to about 2000 microns; 25 microns to about 1500 microns; 30 microns to about 1000 microns; 50 microns to about 800 microns; 100 microns to about 500 microns, with a thickness of about 100 microns to about 250 microns being preferred; however, the exact thickness is not always absolutely critical.

A sign 10 according to the invention may be rigid or flexible, but is preferably flexible. A sign 10 according to the invention may be translucent or opaque, but is preferably opaque to aid in quick recognition of the message displayed on one or more of its face portions. It is essential that the background color is of a different color than the letters to enable sufficient contrast for the message to be legible to a reader. In one preferred form of the invention, the background color of the front face portion 9 and the rear face portion 7 are white, and the letters which comprise the message are a darker color, which may include without limitation the colors red, black, yellow, blue, and combinations of the foregoing, such as combining red and yellow to produce orange, or combining blue and yellow to produce green, etc. The background may be of any color, including without limitation white and translucent, and the letters may be in any font, and any color.

As far as the overall shape of the sign 10, in one embodiment, the placard is shaped substantially as a square, diamond, or rhombus. However, any shape may be employed, including without limitation, circular, oval, octagonal, hexagonal, pentagonal, triangular, etc., and irregular shapes as well.

According to an alternate embodiment, both the front face and the rear face have substantially the same message printed thereon. According to another alternate embodiment, both the front face and the rear face have a substantially different message printed thereon.

According to one preferred form of the invention, the placard is a sheet or layer of a polymeric film, which comprise a material selected from homopolymers or copolymers of any C₂-C₈ olefin, including blends thereof. Included within such materials are ethylene homopolymers and propylene homopolymers. Also included within such materials are copolymers of ethylene with any one or more C₃-C₈ olefinic monomers. Also included within such materials are copolymers of propylene with any one or more of C₂ or C₄-C₈ olefinic monomers. However, any pliable or bendable polymeric film is suitable for use upon which to base a placard of the invention. Thus, the present invention also includes the use of such materials, without limitation, such as PVC, CPVC, EPDM, films made from halogenated alkene polymers, thermoset resins, thermoplastic vulcanizates, composites, thermoplastic resins, etc. According to one embodiment, a placard is composed of a polymeric film material having a crystallinity of any value in the range of between about 35 Joules per gram and 110 Joules per gram, as measured by differential scanning calorimetry according to ASTM Method D-3417, treating the sample as if the sample were a polyolefin, and including all ranges therebetween.

One advantage of using a film such as that described is that advantage of electrostatic forces may be taken in affixing the placard to a surface, such as a window. Thus, by choice of a polymeric film that is pliable, I have found that such a film may be readily adhered to a window surface without the need for any adhesive or other attaching means, and the placard generally remains affixed to such surface. I have also found that such a pliable polymeric placard also adheres well to other smooth surfaces, including smooth walls, furniture, computer screens, and metallic surfaces. Thus, the present invention includes a self-adhering placard made from a pliable polymeric material that is capable of adhering to a smooth surface in the absence of any applied adhesive material.

Thus, the invention comprises a pliable placard or sign, preferably comprised of a polymeric material and having a message printed on one or more sides thereof in characters which contrast against the background of the sign.

The invention also includes the process of alerting a person who visits an area to an existing condition, such as the existence of a living will, a do-not-resuscitate order, the existence of a health care proxy, the use of oxygen, and organ donor provisions, among others, comprising the steps of: 1) providing a sign as described herein; and 2) affixing it in a conspicuous location near a person who is anticipated as needing care in the future, or subject to experience a critical event or be involved in a critical encounter with a health-care provider, including without limitation, a heart attack, stroke, or loss of consciousness.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. This includes subject matter defined by any combination of any one of the various claims appended hereto with any one or more of the remaining claims, including the incorporation of the features and/or limitations of any dependent claim, singly or in combination with features and/or limitations of any one or more of the other dependent claims, with features and/or limitations of any one or more of the independent claims, with the remaining dependent claims in their original text being read and applied to any independent claims so modified. This also includes combination of the features and/or limitations of one or more of the independent claims with features and/or limitations of another independent claims to arrive at a modified independent claim, with the remaining dependent claims in their original text being read and applied to any independent claim so modified. In addition this includes the features of each claim combined with every other claim, either singularly, in toto, or in any measure therebetween. Accordingly, the presently disclosed invention is intended to cover all such modifications and alterations, and is limited only by the scope of the claims which follow.

What is claimed is:

1) A sign that is capable of adhering to a flat or substantially flat surface, including without limitation porous and non-porous surfaces, which sign comprises a flexible sheet of a polymeric material, said sign having a front face portion and a rear face portion, and further comprising a health-related message disposed on one or more of said front face portion and said rear face portion.

2) A sign according to claim 1 wherein said health related message is directed to subject matter selected from the group consisting of: a do-not-resuscitate order; an organ donor provision; the use of oxygen; the existence of a living will; and the existence of a health care proxy.

3) A sign according to claim 1 wherein said sign comprises a material selected from the group consisting of: alpha olefin homopolymers and alpha olefin copolymers, wherein said homopolymers and copolymers include at least one C2-C8 olefin as a monomer.

4) A sign according to claim 1 wherein said polymeric material has a crystallinity between about 35 Joules per gram and 110 Joules per gram, as determined by differential scanning calorimetry according to ASTM D-3417.

5) A sign according to claim 1 wherein said sign has a lettered portion and a background portion, wherein said lettered portion is of a darker color than said background portion.

6) A sign according to claim 1 wherein said sign has a lettered portion and a background portion, wherein said lettered portion is in a lighter color than said background portion.

7) A sign according to claim 1 wherein said sign has a lettered portion and a background portion, wherein said background portion is translucent.

8) A sign according to claim 1 wherein said sign has a lettered portion and a background portion, wherein said background portion is opaque.

9) A sign according to claim 1 which exists substantially in the shape of a geometric shape selected from the group consisting of: circle, square, rhombus, diamond, triangle (equilateral, isosceles, scalene) pentagon, hexagon, heptagon, and octagon.

10) A combination comprising:
a) a flat surface; and
b) a sign according to claim 1 adhered to said surface by electrostatic forces, wherein said health related message contains subject matter selected from the group consisting of: a do-not-resuscitate order; an organ donor provision; the use of oxygen; the existence of a living will; and the existence of a health care proxy.

11) A combination according to claim 10 wherein said flat surface comprises a horizontal surface.

12) A combination according to claim 10 wherein said flat surface comprises a vertical surface.

13) A combination according to claim 12 wherein said vertical surface is a surface selected from the group consisting of: a wall, a mirror, and a window.

14) A process for informing a first person of medically-related information of a second person which comprises the steps of:
a) providing a sign according to claim 1;
b) providing a written message on at least one face of said sign that contains personal information;
c) placing said sign on a flat surface, in the substantial absence of an adhesive substance, wherein said flat surface is in a conspicuous location relative to the general whereabouts of the person to whom said information pertains,
so as to provide a display of such information, sufficient to alert persons visiting said conspicuous location as to the existence of said information.
